(19) United States
(12) Patent Application Publication
(10) Pub. No.: US 2021/0120843 A1
(43) Pub. Date: Apr. 29, 2021

(54) HIGH-PURITY RICE PROTEIN POWDER, METHODS FOR PREPARATION AND APPLICATION THEREOF

(71) Applicant: WUXI JINNONG BIOTECHNOLOGY CO., LTD, Wuxi City (CN)

(72) Inventors: Xi ZHU, Wuxi City (CN); Qiusheng YU, Wuxi City (CN); Huili YU, Wuxi City (CN)

(21) Appl. No.: 16/962,846

(22) PCT Filed: Jul. 30, 2019
(86) PCT No.: PCT/CN2019/098295

§ 371 Date: Jul. 17, 2020

(30) Foreign Application Priority Data
Dec. 3, 2018 (CN) 201811463004.8

(51) Int. Cl. A23J 1/12; A23L 7/104; A23L 7/126; A23L 33/185

(52) U.S. Cl. CPC A23J 1/125; A23L 7/107; A23V 2002/00; A23L 33/185; A23L 7/126

(57) ABSTRACT

The present invention provides a high-purity rice protein powder. Preparation for the rice protein powder includes steps as follows: (1) crushing rice and adjusting slurry; (2) enzymolysis and filtering; (3) adjusting rice residue and crashing it; (4) adding a composite surfactant; (5) using a 12-stage cyclone washing device to separate light liquid phase from heavy liquid phase; (6) adding compound enzyme to the heavy liquid phase, thereby obtaining an enzymolysis solution; (7) spray sterilizing the enzymolysis solution, and using plate-and-frame member for filter-press, collecting a filter cake, drying by an airflow, and superfine grinding by dry processing, thereby obtaining the high-purity rice protein powder. The invention uses rice as raw material and a composite surfactant as the main means of degreasing and decellulose, thereby preparing a high-purity rice protein powder in high purity, mild processing technology, small changes in protein structure properties, better taste, and good suspension stability.

### CROSS-REFERENCES TO RELATED APPLICATIONS

This application is a 371 application of the International Patent Application No. PCT/CN2019/098295 filed on Jul. 30, 2019, which claims priority from the Chinese patent application No. 201811463004.8 filed on Dec. 3, 2018, and the disclosures of which are incorporated herein by reference in their entirety.

### FIELD OF THE INVENTION

The invention relates to the field of food technology, in particular to a high-purity rice protein powder, methods for preparation and application thereof.

### BACKGROUND OF THE INVENTION

Rice protein powder refers to protein extracted from rice, which is mainly a powdery substance formed by processing steps of crushing, purifying, and drying rice residue. Rice protein powder is an important product in deep processing of rice, which can be divided into feed-grade rice protein, high-purity food-grade rice protein powder, and rice protein peptide according to its protein content and solubility. Rice protein is mainly composed of albumin, globulin, alcohol-soluble protein, and gluten. Rice protein has a reasonable amino acid composition and high amino acid content, which results in being recognized as a high-quality edible protein. Rice protein powder has broad prospects for development into infant food and high-class food due to its high nutritional value and low allergy.

Conventional methods for preparing high-purity rice protein powder include alkaline approach, protease approach, and impurity removal approach. During extraction in the alkaline approach, the rice protein structure is changed to make the functional properties thereof poor, and toxic substances would be produced. For the protease approach, extraction rate thereof is not high and protein purity is not ideal, and the resulting product may produce a strong bitter taste. For the impurity removal approach, it starts with rice residue to run enzymatic hydrolysis of fat, residual starch granules, cellulose, and other insoluble materials in the rice residue, so as to separate them from the rice residue protein, resulting in increase in protein content of the protein. However, in such approach, a row material process and processing techniques for fat, starch, or cellulose are not perfect, which would greatly change the protein structure.

Among the existing technologies, extraction of rice protein is started from rice residue and high-temperature drying is performed in the middle stage of the process, which results in reduced ductility, foaming, and stability of the protein and make the structure difficult to open, and it is disadvantageous to subsequent purification processes. For degreasing, an alkaline saponification approach is usually used. Such approach has low degreasing efficiency (some of fat bounding to protein have not been removed), and high concentration of alkali may change functional properties of the protein. The enzyme preparation for removing cellulose is relatively simple and thus cannot dissolve more colloidal substances. At present, content of high-purity rice protein powder in the conventional products is not high enough, and the taste is not delicate enough.

### SUMMARY OF THE INVENTION

With respect to the above problems in the existing technology, the present invention provides a high-purity rice protein powder, methods for preparation and application thereof. The present invention has strong practicability, uses rice as raw material, and takes a composite surfactant as main approaches of degreasing and decellulose to prepare a high-purity rice protein powder. The present invention yields high purity product, employs mild processing technology, results in only small changes in protein structure with better taste and better suspension stability; it is also a high-quality raw material for subsequent preparation of rice active protein peptides.

The technical solution of the present invention is as follows:

A high-purity rice protein powder is provided, in which the method for preparing a high-purity rice protein powder includes steps as follows.

(1) Rice is immersed in water for 2-4 hours and is crushed, and then a 100 mesh sieve is used to let the crushed rice to pass through, such that a slurry with a mass concentration of 10-15% is obtained;

(2) A high temperature amylase is added into the slurry obtained in the step (1) and then liquidified by spraying, followed by using a plate-and-frame member for filter-press the liquid to obtain a rice residue;

(3) The mass concentration of the rice residue obtained in the step (2) is adjusted to 5-15% and the rice residue is crushed by using a colloid mill and a fine crusher until a particle size of a feed liquid is crushed to become 20-40 μm.

(4) A composite surfactant is added to the feed liquid obtained in the step (3) with adjusting pH at 6.5-8.5, and stirring reaction in a water bath at 40-60° C. for 1-4 hours is performed.

(5) The feed liquid obtained in step (4) is brought to pass through a 12-stage cyclone washing device, thereby separating light liquid phase from heavy liquid phase.

(6) A compound enzyme is added into the heavy liquid phase obtained in the step (5) and stirring reaction at a temperature of 40-60° C. and pH of 4.0-6.0 for 1-4 hours is performed, so as to prepare an enzymolysis solution.

(7) Spray sterilization is performed on the enzymolysis solution obtained in the step (6) and then plate-and-frame member is used for filter-press. A filter cake is collected and is dried by an airflow, and then superfine grinding by dry processing is performed until it makes the filter cake have a median diameter of 10-20 thereby obtaining the high purity rice protein powder.

The rice includes japonica rice, indica rice, glutinous rice, or combinations thereof.

The dosage of the high temperature amylase in the step (2) is in 5‰ of dry weight, the liquefaction by spraying performed in the step (2) is at a temperature of 115-120° C., and the temperature after the liquefaction by spraying is kept at 95-98° C. for 30-90 minutes.

The composite surfactant in the step (4) is in an oil-in-water type with HLB value of 8-20. The composite surfactant is prepared by mixing two or three of lecithin, soybean phospholipid, glyceryl monostearate, Tween 20, Tween 60, Tween 80, sucrose esters, polyglycerol esters, fatty acid propylene glycol esters, and span, and the added amount of the composite surfactant is at 1-8‰ by dry weight.

The compound enzyme in the step (6) is a mixture of cellulase and pectinase with a mass ratio of 0.5-1:1-2.5, and the dosage of the compound enzyme is at 0.5-1.5% by weight of the heavy liquid phase.

A method for applying the high-purity rice protein powder is provided, which includes using high-purity rice protein powder to prepare a high-protein energy bar.

A method for preparing the high-protein energy bar includes steps as follows: 10-40 units of high-purity rice protein crisp grains which have been extruded and puffed, 0-10 units of ripened oatmeal, 5-15 units of pregelatinized rice starch, 20-40 units of malt syrup, 5-15 units of fructose syrup, 5-10 units of high-purity rice protein powders, 2-5 units of nuts, and 1-5 units of preserved fruit are formulated, mixed, frozen to shape, and cut, to obtain a rod-shape food, which is the high-protein energy bar.

The high-purity rice protein crisp grains are prepared by extruding the high-purity rice protein powder after high-temperature puffing.

A method for applying the high-purity rice protein powder is provided, which includes mixing the rice protein powder with one or more of soy protein, pea protein, wheat protein, pea protein, hemp protein, adlay protein, and potato protein, so as to prepare a composite vegetable protein powder.

The rice can be replaced by black rice in the present invention.

The beneficial technical effects of the present invention are as follows.

The invention innovatively uses rice as a raw material in combination with crushing, liquefaction by spraying, and other processes to completely open structures of protein and starch and to completely the starch, so as to obtain rice residue with a certain protein content, which maintains most of the structural properties of the protein and is advantageous to subsequent purification treatment. Then, fine crushing and colloid mill are used to completely disperse feed liquid, and a composite surfactant and cyclone washing are applied such that fat is freed under non-alkalized conditions on the one hand. Gradient elution is performed and thus degreasing effect is more significant, so as to obtain higher purity rice protein. n the other hand, surfactants are used to open a chelate bond between fat and cellulose (or other colloids). At the same time, pectinase and cellulase can be reasonably used for compound enzymatic hydrolysis, such that the remaining cellulose, colloids, pigments, and other substances are completely hydrolyzed, thereby maximizing the purity of rice protein. After spray sterilization, plate-and-frame member is used for filter-press, and then dried, high-purity rice protein powder is obtained with maximum efficiency. The final product is crushed through superfine grinding by dry processing until a median diameter of 10-20 μm is reached, thereby achieving the lower limit of the particle size that the tongue can still feel. The product is close to no powder feeling, with better taste and suspension stability.

### BRIEF DESCRIPTION OF THE DRAWINGS

FIG. 1 is a schematic diagram of the present invention.

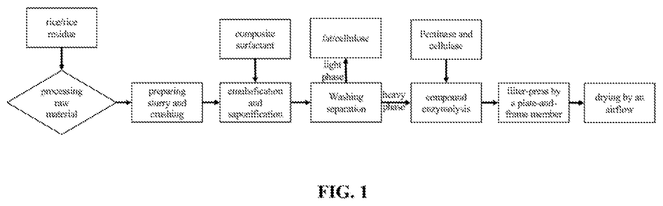

### DETAILED DESCRIPTION

Detailed description to the present invention is provided with drawings and embodiments as follows.

### Embodiment 1

A high-purity rice protein powder is provided, in which a preparation method for the rice protein powder includes steps as follows.

(1) Glutinous rice is immersed in water for 2 hours and then is crushed, and thereafter a 100 mesh sieve is used to let it pass through such that a slurry in a mass concentration of 10% is prepared.

(2) A high temperature amylase with 5‰ of dry weight is added to the slurry obtained in the step (1), and then liquidified by spraying at 115° C. is performed and the temperature is kept at 95° C. for 30 minutes after the liquefaction by spraying. A plate-and-frame member is used for filter-press, so as to collect rice residue.

(3) The mass concentration of the rice residue obtained in the step (2) is turned into 5% and then the rice residue is crushed by using a colloid mill and a fine crusher until a particle size of a feed liquid is crushed to become 20 μm.

(4) A composite surfactant (lecithin, Tween 80, and span mixture, with HLB value of 8-20) in 1‰ of dry weight is added to the feed liquid obtained in the step (3) with adjusting pH at 8.5, and stirring reaction in a water bath at 40° C. for 4 hours is performed.

(5) The feed liquid obtained in step (4) is brought to pass through a 12-stage cyclone washing device, thereby separating light liquid phase from heavy liquid phase.

(6) A mixture of cellulase and pectinase (by a mass ratio of 0.5:1) at 0.5% of the weight of the heavy liquid phase is added into the heavy liquid phase collected in the step (5) with stirring reaction at a temperature of 40° C. and pH of 4.0 for 4 hours, so as to prepare an enzymolysis solution.

(7) Spray sterilization is performed on the enzymolysis solution obtained in the step (6), and then plate-and-frame member is used for filter-press. A filter cake is collected and is dried by an airflow, and then superfine grinding by dry processing is performed until it makes the filter cake have a median diameter of 20 thereby obtaining a high purity rice protein powder.

### Embodiment 2

A high-purity rice protein powder is provided, in which a preparation method for the rice protein powder includes steps as follows.

(1) Japonica rice is immersed in water for 3 hours and then is crushed, and thereafter a 100 mesh sieve is used to let it pass through such that a slurry with a mass concentration of 12% is prepared.

(2) A high temperature amylase with 5‰ of dry weight is added to the slurry obtained in the step (1), and then liquidified by spraying at 117° C. is performed and the temperature is kept at 96° C. for 60 minutes after the liquefaction by spraying. A plate-and-frame member is used for filter-press, so as to collect rice residue.

(3) The mass concentration of the rice residue obtained in the step (2) is turned into 10% and then the rice residue is crushed by using a colloid mill and a fine crusher until a particle size of a feed liquid is crushed to become 40 μm.

(4) A composite surfactant (soy lecithin, glycerol monostearate, and Tween 20 mixture, with HLB value of 8-20) with 4‰ of dry weight is added to the feed liquid obtained in the step (3) with adjusting pH at 7, and stirring reaction in a water bath at 50° C. for 2.5 hours is performed.

(5) The feed liquid obtained in step (4) is brought to pass through a 12-stage cyclone washing device, thereby separating light liquid phase from heavy liquid phase.

(6) A mixture of cellulase and pectinase (by a mass ratio of 0.75:2.0) at 1.0% of the weight of the heavy liquid phase is added into the heavy liquid phase collected in the step (5) with stirring reaction at a temperature of 50° C. and pH of 5.0 for 2.5 hours, so as to prepare an enzymolysis solution.

(7) Spray sterilization is performed on the enzymolysis solution obtained in the step (6), and then plate-and-frame member is used for filter-press. A filter cake is collected and is dried by an airflow, and then superfine grinding by dry processing is performed until it makes the filter cake have a median diameter of 15 thereby obtaining a high purity rice protein powder.

### Embodiment 3

A high-purity rice protein powder is provided, in which a preparation method for the rice protein powder includes steps as follows.

(1) indica rice is immersed in water for 4 hours and then is crushed, and thereafter a 100 mesh sieve is used to let it pass through such that a slurry with a mass concentration of 15% is prepared.

(2) A high temperature amylase with 5‰ of dry weight is added to the slurry obtained in the step (1), and then liquidified by spraying at 120° C. is performed and the temperature is kept at 98° C. for 90 minutes after the liquefaction by spraying. A plate-and-frame member is used for filter-press, so as to collect rice residue.

(3) The mass concentration of the rice residue obtained in the step (2) is turned into 15% and then the rice residue is crushed by using a colloid mill and a fine crusher until a particle size of a feed liquid is crushed to become 30 μm.

(4) A composite surfactant (Tween 60, sucrose ester, and mixture of polyglycerol ester, with HLB value of 8-20) with 8‰ of dry weight is added to the feed liquid obtained in the step (3) with adjusting pH at 6.5, and stirring reaction in a water bath at 60° C. for 4 hours is performed.

(5) The feed liquid obtained in step (4) is brought to pass through a 12-stage cyclone washing device, thereby separating light liquid phase from heavy liquid phase.

(6) A mixture of cellulase and pectinase (by a mass ratio of 1:2.5) at 1.5% of the weight of the heavy liquid phase is added into the heavy liquid phase collected in the step (5) with stirring reaction at a temperature of 60° C. and pH of 6.0 for 1 hour, so as to prepare an enzymolysis solution.

(7) Spray sterilization is performed on the enzymolysis solution obtained in the step (6), and then plate-and-frame member is used for filter-press. A filter cake is collected and is dried by an airflow, and then superfine grinding by dry processing is performed until it makes the filter cake have a median diameter of 10 thereby obtaining a high purity rice protein powder.

### Embodiment 4

A high-purity rice protein powder is provided, in which a preparation method for the rice protein powder includes steps as follows.

(1) Black rice is immersed in water for 4 hours and then is crushed, and thereafter a 100 mesh sieve is used to let it pass through such that a slurry with a mass concentration of 15% is prepared.

(2) A high temperature amylase with 5‰ of dry weight is added to the slurry obtained in the step (1), and then liquidified by spraying at 120° C. is performed and the temperature is kept at 98° C. for 90 minutes after the liquefaction by spraying. A plate-and-frame member is used for filter-press, so as to collect rice residue.

(3) The mass concentration of the rice residue obtained in the step (2) is turned into 15% and then the rice residue is crushed by using a colloid mill and a fine crusher until a particle size of a feed liquid is crushed to become 30 μm.

(4) A composite surfactant (Tween 20, sucrose ester, and mixture of fatty acid propylene glycol ester, with HLB value of 8-20) with 8‰ of dry weight is added to the feed liquid obtained in the step (3) with adjusting pH at 6.5, and stirring reaction in a water bath at 60° C. for 4 hours is performed.

(5) The feed liquid obtained in step (4) is brought to pass through a 12-stage cyclone washing device, thereby separating light liquid phase from heavy liquid phase

(6) A mixture of cellulase and pectinase (by a mass ratio of 1:2.5) at 1.5% of the weight of the heavy liquid phase collected in the step (5) is added into the heavy liquid phase with stirring reaction at a temperature of 60° C. and pH of 6.0 for 1 hour, so as to prepare an enzymolysis solution.

(7) Spray sterilization is performed on the enzymolysis solution obtained in the step (6), and then plate-and-frame member is used for filter-press. A filter cake is collected and is dried by an airflow, and then superfine grinding by dry processing is performed until it makes the filter cake have a median diameter of 10 thereby obtaining a high purity rice protein powder.

The performance of the rice protein powders obtained in embodiments 1-4 is tested, and test results are shown in Table 1:

TABLE 1

| Item | Protein Content (%) | Fat Content (%) | Ash (%) |
|---|---|---|---|
| Embodiment 1 | 94.2 | 0.73 | 0.95 |
| Embodiment 2 | 95.1 | 0.52 | 1.02 |
| Embodiment 3 | 93.6 | 0.94 | 1.27 |
| Embodiment 4 | 90.4 | 1.20 | 1.06 |

### Embodiment 5

The rice protein powder prepared in embodiment 1 is configured to prepare a high-protein energy bar. Such preparation method includes steps as follows. 10 units of high-purity rice protein crisp grains which have been extruded and puffed, 5 units of pregelatinized rice starch, 20 units of malt syrup, 5 units of fructose syrup, 5 units of high-purity rice protein powders, 2 units of nuts, and 1 unit of preserved fruit are provided, and then a rod-shaped food is made by distributing, mixing, freezing molding, and cutting the above materials, thereby preparing the high-protein energy bar.

The high-purity rice protein crisp grains are prepared by extruding the high-purity rice protein powder after high-temperature puffing.

### Embodiment 6

The rice protein powder prepared in embodiment 1 is configured to prepare a high-protein energy bar. Such preparation method includes steps as follows. 25 units of high-purity rice protein crisp grains which have been extruded and puffed, 5 units of ripened oatmeal, 10 units of pregelatinized rice starch, 30 units of malt syrup, 10 units of fructose syrup, 7 units of high-purity rice protein powders, 4 parts of nuts, 3 parts of preserved fruit are provided, and then a rod-shaped food is made by distributing, mixing, freezing molding, and cutting the above materials, thereby preparing the high-protein energy bar.

The high-purity rice protein crisp grains are prepared by extruding the high-purity rice protein powder after high-temperature puffing.

### Embodiment 7

The rice protein powder prepared in embodiment 1 is configured to prepare a high-protein energy bar. Such preparation method includes steps as follows. 40 units of high-purity rice protein crisp grains which have been extruded and puffed, 10 units of ripened oatmeal, 15 units of pregelatinized rice starch, 40 units of malt syrup, 15 units of fructose syrup, 10 units of high-purity rice protein powders, 5 units of nuts, 5 units of preserved fruit are provided, and then a rod-shaped food is made by distributing, mixing, freezing molding, and cutting the above materials, thereby preparing the high-protein energy bar.

The high-purity rice protein crisp grains are prepared by extruding the high-purity rice protein powder after high-temperature puffing.

### Embodiment 8

The high-purity rice protein powder prepared in embodiment 1 is configured to prepare a composite vegetable protein powder. Such preparation method includes step as follows. High-purity rice protein powder, soybean protein, pea protein, and wheat protein are provided in percentage of 50%, 20%, 20%, and 10%, respectively, and mixed together.

### Embodiment 9

The high-purity rice protein powder prepared in embodiment 1 is used to prepare a composite vegetable protein powder. Such preparation method includes step as follows. High-purity rice protein powder, hemp protein, pearl barley protein, and potato protein are provided in percentage of 50%, 20%, 20%, and 10%, respectively, and mixed together.

1. A high-purity rice protein powder prepared by a method, the method comprising:
(1) immersing rice in water for 2-4 hours, followed by crushing thereof, and passing thereof through a 100 mesh sieve, such that a slurry with a mass concentration of 10-15% is obtained;
(2) adding a high temperature amylase in 5‰ of dry weight to the slurry obtained in the step (i) and then liquidifying thereof by spraying, and using a plate-and-frame member for filter-press thereof to collect rice residue;
(3) adjusting the mass concentration of the rice residue obtained in the step (ii) to 5-15% and crushing the rice residue by using a colloid mill and a fine crusher to obtain a feed liquid with a particle size of reaches 20-40 μm;
(4) adding a composite surfactant in 1‰ of dry weight to the feed liquid obtained in the step (iii) with adjusting pH at 6.5-8.5 and performing stirring reaction in a water bath at 40-60° C. for 1-4 hours;
(5) passing the feed liquid obtained in step (iv) through a 12-stage cyclone washing device, thereby separating light liquid phase from heavy liquid phase;
(6) adding a compound enzyme into the heavy liquid phase collected in the step (v) followed by stirring at a temperature of 40-60° C. and pH of 4.0-6.0 for 1-4 hours, so as to obtain an enzymolysis solution; and
(7) spray sterilizing the enzymolysis solution obtained in the step (vi) followed by using a plate-and-frame member for filter-press, collecting a filter cake after the filter-press and drying thereof by an airflow, and then superfine grinding the dried filter cake by dry processing until the grinds of the filter cake has a median diameter of 10-20 thereby obtaining the high-purity rice protein powder.

2. The high-purity rice protein powder of claim 1, wherein the rice comprises japonica rice, indica rice, glutinous rice, or combinations thereof.

3. The high-purity rice protein powder of claim 1, wherein the dosage of the high temperature amylase in the step (2) is in 5‰ of dry weight, the liquefaction by spraying performed in the step (2) is in a temperature of 115-120° C., and the temperature after the liquefaction by spraying is kept at 95-98° C. for 30-90 minutes.

4. The high-purity rice protein powder of claim 1, wherein the composite surfactant in the step (4) is in an oil-in-water type with HLB value of 8-20; the composite surfactant is prepared by mixing two or three of lecithin, soybean phospholipid, glyceryl monostearate, Tween 20, Tween 60, Tween 80, sucrose esters, polyglycerol esters, fatty acid propylene glycol esters, and span; and the added amount of the composite surfactant is in 1-8‰ of dry weight.

5. The high-purity rice protein powder of claim 1, wherein the compound enzyme in the step (6) is a mixture of cellulase and pectinase with a mass ratio of 0.5-1:1-2.5; and the dosage of the compound enzyme is in 0.5-1.5% of the weight of the heavy liquid phase.

6. A method for applying the high-purity rice protein powder of claim 1, comprising:
providing the high-purity rice protein powder to prepare a high-protein energy bar.

7. The method of claim 6, wherein a preparation method for the high-protein energy bar comprises:
providing 10-40 units of high-purity rice protein crisp grains which have been extruded and puffed, 0-10 units of ripened oatmeal, 5-15 units of pregelatinized rice starch, 20-40 units of malt syrup, 5-15 units of fructose syrup, 5-10 units of high-purity rice protein powders, 2-5 units of nuts, and 1-5 units of preserved fruit to make a rod-shaped food through distributing, mixing, freezing molding, and cutting, thereby preparing the high-protein energy bar.

8. The method of claim 6, wherein the high-purity rice protein crisp grains are prepared by extruding the high-purity rice protein powder after high-temperature puffing.

9. A method for applying the high-purity rice protein powder of claim 1, comprising:
mixing the rice protein powder with one or more of soy protein, pea protein, wheat protein, pea protein, hemp protein, adlay protein, and potato protein, so as to prepare a composite vegetable protein powder.

10. The method for preparing the high-purity rice protein powder of claim 1, wherein the rice is available to be replaced by black rice.

11. A method for preparing a high-purity rice protein powder, the method comprising:
(1) immersing rice in water for 2-4 hours, followed by crushing thereof, and passing thereof through a 100 mesh sieve, such that a slurry with a mass concentration of 10-15% is obtained;
(2) adding a high temperature amylase in 5‰ of dry weight to the slurry obtained in the step (i) and then liquidifying thereof by spraying, and using a plate-and-frame member for filter-press thereof to collect rice residue;
(3) adjusting the mass concentration of the rice residue obtained in the step (ii) to 5-15% and crushing the rice residue by using a colloid mill and a fine crusher to obtain a feed liquid with a particle size of reaches 20-40 μm;
(4) adding a composite surfactant in 1‰ of dry weight to the feed liquid obtained in the step (iii) with adjusting pH at 6.5-8.5 and performing stirring reaction in a water bath at 40-60° C. for 1-4 hours;
(5) passing the feed liquid obtained in step (iv) through a 12-stage cyclone washing device, thereby separating light liquid phase from heavy liquid phase;
(6) adding a compound enzyme into the heavy liquid phase collected in the step (v) followed by stirring at a temperature of 40-60° C. and pH of 4.0-6.0 for 1-4 hours, so as to obtain an enzymolysis solution; and
(7) spray sterilizing the enzymolysis solution obtained in the step (vi) followed by using a plate-and-frame member for filter-press, collecting a filter cake after the filter-press and drying thereof by an airflow, and then superfine grinding the dried filter cake by dry processing until the grinds of the filter cake has a median diameter of 10-20 thereby obtaining the high-purity rice protein powder.

12. The method of claim 11, wherein the rice comprises japonica rice, indica rice, glutinous rice, or combinations thereof.

13. The method of claim 11, wherein the dosage of the high temperature amylase in the step (2) is in 5‰ of dry weight, the liquefaction by spraying performed in the step (2) is in a temperature of 115-120° C., and the temperature after the liquefaction by spraying is kept at 95-98° C. for 30-90 minutes.

14. The method of claim 11, wherein the composite surfactant in the step (4) is in an oil-in-water type with HLB value of 8-20; the composite surfactant is prepared by mixing two or three of lecithin, soybean phospholipid, glyceryl monostearate, Tween 20, Tween 60, Tween 80, sucrose esters, polyglycerol esters, fatty acid propylene glycol esters, and span; and the added amount of the composite surfactant is in 1-8‰ of dry weight.

15. The method of claim 11, wherein the compound enzyme in the step (6) is a mixture of cellulase and pectinase with a mass ratio of 0.5-1:1-2.5; and the dosage of the compound enzyme is in 0.5-1.5% of the weight of the heavy liquid phase.

16. A method for applying the high-purity rice protein powder of claim 11, comprising:
providing the high-purity rice protein powder to prepare a high-protein energy bar.

17. The method of claim 16, wherein a preparation method for the high-protein energy bar comprises:
providing 10-40 units of high-purity rice protein crisp grains which have been extruded and puffed, 0-10 units of ripened oatmeal, 5-15 units of pregelatinized rice starch, 20-40 units of malt syrup, 5-15 units of fructose syrup, 5-10 units of high-purity rice protein powders, 2-5 units of nuts, and 1-5 units of preserved fruit to make a rod-shaped food through distributing, mixing, freezing molding, and cutting, thereby preparing the high-protein energy bar.

18. The method of claim 16, wherein the high-purity rice protein crisp grains are prepared by extruding the high-purity rice protein powder after high-temperature puffing.
